(19) United States
(12) Patent Application Publication
(10) Pub. No.: US 2013/0058516 A1
(43) Pub. Date: Mar. 7, 2013

(54) CARTRIDGE FOR MANAGING EAR BUD CABLES HAVING A CONSTANT TORQUE SPRING

(71) Applicants: Daniel C. Sullivan, Santa Barbara, CA (US); John Cataldo, Westlake Village, CA (US); Mardis Bagley, San Francisco, CA (US)

(72) Inventors: Daniel C. Sullivan, Santa Barbara, CA (US); John Cataldo, Westlake Village, CA (US); Mardis Bagley, San Francisco, CA (US)

(73) Assignee: HEADLOGIC LLC, Westlake Village, CA (US)

(21) Appl. No.: 13/405,158

(22) Filed: Feb. 24, 2012

Related U.S. Application Data
(60) Provisional application No. 61/447,816, filed on Mar. 1, 2011.

(51) Int. Cl. B65H 75/48; F03G 1/00; H04R 1/10

(52) U.S. Cl. 381/380; 185/37

(57) ABSTRACT

A cartridge for managing ear bud cables includes a housing, a hub, a spool and an ear bud cable. Rotation of the spool selectively retracts and dispenses the ear bud cables while enabling continuous audio communication between the at least one ear bud and an audio device. A motor assembly rotates the spool. The motor assembly includes a drive gear and a first storage drum, a first constant torque spring wound at least partially about the first storage drum and the drive gear for applying torque to the drive gear. The first storage drum and the drive gear are distanced from each other to enable a length of the spring to extends between the storage drum and the drive gear to apply constant torque to the drive gear. The constant torque has a variability of no more than +/−10%.

### PRIORITY CLAIM

This invention claims priority to U.S. Provisional Patent Application Ser. No. 61/447,816, filed 1 Mar. 2011, the disclosure of which is incorporated herein by reference.

### FIELD OF THE INVENTION

The present invention relates to ear bud cables and particularly to devices for dispensing and retracting ear bud cables.

### BACKGROUND OF THE INVENTION

Ongoing research indicates a relationship between prolonged exposure to cell phone radiation and illness including cancer. The risk of illness decreases significantly where cell phones are used at a distance from the user. Positioning a cell phone even a few inches away the ear can greatly reduce harm from cell phone radiation.

There are several ways to manage the health risks associated with prolonged cell phone use. One way is to use a speakerphone and hold the phone at a distance. However, many do not want their phone conversations overheard, or to disturb others with a loud two-way conversation. Additionally, prolonged use of the speakerphone can greatly reduce battery life.

Another way to reduce health risks associated with cell phone use is to use a Bluetooth headset. The energy radiated by a phone with a typical Bluetooth headset is orders of magnitude less than a cellular phone signal. Bluetooth technology requires sufficient power to communicate over a number of feet, where cell phone signals require sufficient power to communicate thousands of feet, and sometimes miles, between the cell phone and a distant cell phone tower.

Yet another way to reduce health risks is to use a wired headset. Wired ear buds may, for example, insert into a user's ear, hang on the ear, or hang on the head. Ear buds are energy efficient and have lessened health risks due to radiation. When two ear buds are used, stereo sound is possible.

One major drawback of using wired ear buds with portable consumer electronics devices and telephones is cord management. Cord management is a commonly experienced problem where the cord of the ear buds becomes tangled and may be damaged by a frustrated user who attempts to hastily untangle the cord. Operating an automobile, a bicycle, or other vehicle while experiencing cord management problems can be dangerous. What is desired is a better way of cord management which enables the user to readily extend and retract ear bud cables in a rapid, safe and reliable manner.

### SUMMARY OF THE INVENTION

A cartridge for managing an ear bud cable includes a housing having an audio jack, a spool rotatably mounted in the housing for spooling an ear bud cable, and an ear bud cable wrapped at least partially around the spool.

The ear bud cable is flat, and has a first end, a width, and a second end. The first end being electrically connected with the audio jack via the spool and the second end having at least one ear bud. Using a flat ear bud cable minimizes entanglement of the cable, eases wrapping of the cable on the spool, and minimizes the size of the cable.

The cartridge includes a motor assembly mounted in the housing in operative contact with the spool. The motor assembly includes a drive gear, at least one storage drum and at least one constant torque spring wound at least partially about the storage drum and the drive gear.

The storage drum and the drive gear are distanced from each other to enable a length of the spring to extend in a linear manner between the storage drum and the drive gear to apply constant torque to the drive gear. The distance is adjustable and can be adjusted to vary to vary the torque applied to the drive gear.

The constant torque spring has a width, and the ear bud cable has a width, the width of the constant torque spring is no greater than the width of the ear bud cable to minimize the thickness of the cartridge. In one embodiment, the constant torque spring has a width, and the ear bud cable has a width, the width of the constant torque spring is approximately the same as the width of the ear bud cable.

The constant torque spring applies constant torque to the drive gear, the constant torque varies less than 10% as the drive gear moves. Preferably the constant torque varies less than 5% in operation.

The drive gear has an outside diameter and the storage drum has an outside diameter, which is less than the drive gear outside diameter. In one embodiment, the spool has an outside diameter, which is less than the drive gear outside diameter. Preferably the drive gear has gear teeth, which engage the spool in operation. In an alternate embodiment a friction surface, other than gear teeth is used.

### BRIEF DESCRIPTION OF THE DRAWINGS

FIG. 1 shows a perspective view of a cartridge for managing ear bud cable in accordance with the present invention.

FIG. 2 shows a cut-away perspective view of the cartridge of FIG. 1 including a constant torque spring.

FIG. 3 shows a perspective view of a motor assembly having multiple storage drums and constant torque springs extending between the storage drums and the drive gear.

FIG. 4 shows a side view of the motor assembly of FIG. 3.

FIG. 5 shows a graph of an improved torque curve of a constant torque spring compared with a typical power spring.

### DETAILED DESCRIPTION

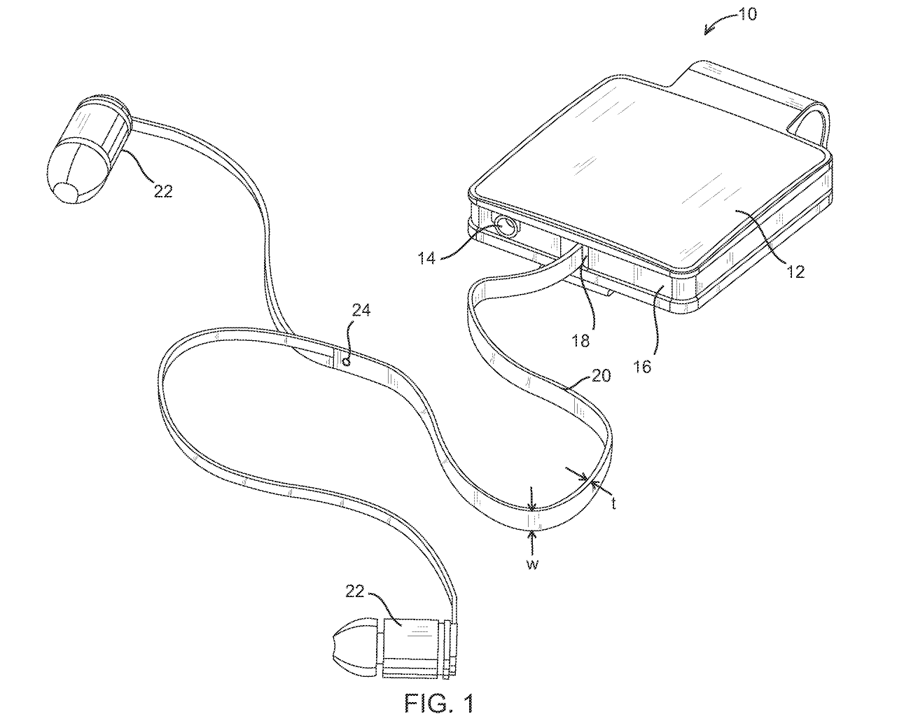

FIG. 1 is a cartridge generally designated by the reference numeral 10. The cartridge 10 includes housing 12 having a circuit board 15 with an audio jack 14 and a wireless receiver. The cartridge 10 includes a lateral side 16 defining an opening 18. The cartridge 10 also includes a retractable ear bud cable 20 mounted within the housing 12, and extending through the opening 18.

Preferably the audio jack 14 is a hard wired auxiliary audio jack, and the circuit board 15 includes a wireless receiver to enable the cartridge to function as a stand-alone device that communicated wirelessly with an audio device.

The audio jack 14 is attached on a portion of the housing 12 to enable the cartridge 10 to mate, in a hard-wired fashion, with an audio device.

The receiver incorporates wireless technology such as a Bluetooth, infrared, optical, radio, 801.11, or similar wireless communication technology. The receiver functions also functions as a transmitter to transmit audio signals detected by the microphone 24, and to transmit protocol information, handshakes and other instructional and control messages to an audio device.

The ear bud cable 20 includes a first end with at least one ear bud 22 and a second end attached within the housing in electrical communication with the audio jack 14. The ear bud cable 20 includes a flat wire to minimize thickness of the cable 20 and to minimize any likelihood of entanglement of the cable 20 around itself and other objects. The term ear bud as used herein includes mini-speakers that insert into the ear of a user, hang on the ear of a user, or otherwise attach to the head of a user.

The cable 24 preferably includes a microphone 24 for use with telephonic applications. The cable 20 has a width “w” and a thickness “t”. The cable 24 is flat and the width “w”, and a thickness “t”. The width “w” is more than twice the thickness “t”. The thickness “t” is minimized to enable cartridge 10 to maximize the amount of cable 24 that can be managed by the cartridge 10.

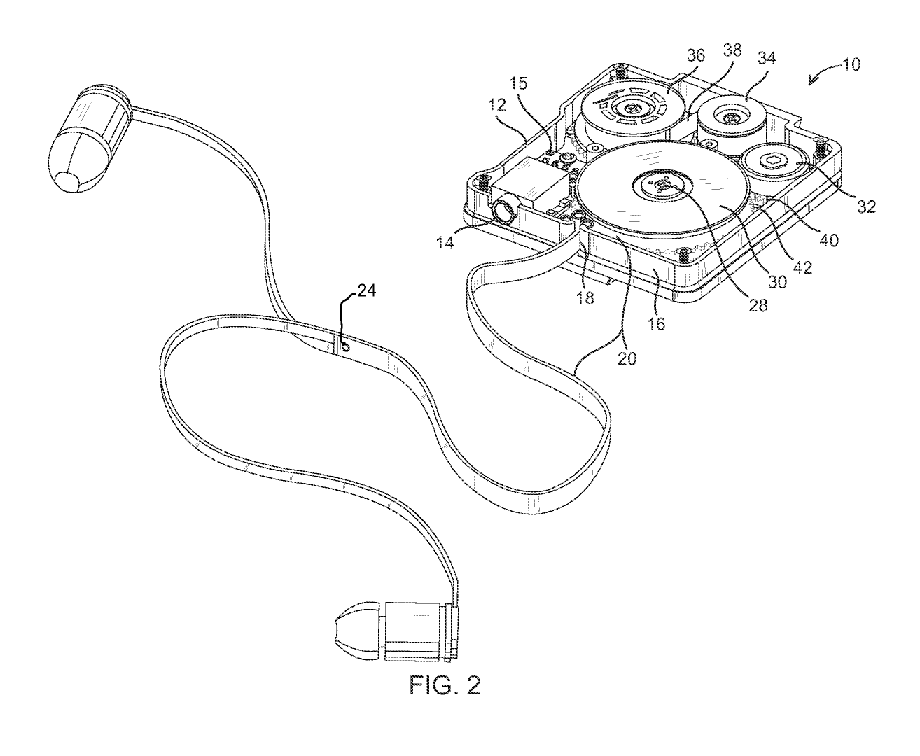

FIG. 2 shows the cartridge 10. The housing 12 includes a hub 28 that supports the spool 30 and electrically connects the spool 30 to the audio jack 14. The spool 30 rotatably mounts on the hub 28. Rotation of the spool 30 dispenses and retracts the ear bud cable 20 from the housing 12 via the opening 18.

The cartridge 10 includes motor assembly mounted in the housing in operative contact with the spool 30. The motor assembly includes a storage drum 34, a drive gear 36, a constant torque spring 38 wound at least partially about the storage drum 34 and the drive gear 36. The motor assembly also includes a rotary damper 32 is rotatably mounted within the housing 12 in operative contact with the spool 30.

The rotary damper 32 mates in operative contact with the spool 30 so that the rotary damper 32 presses against the spool 30. In particular, both the rotary damper 32 and the spool 30 each have a periphery. The periphery of the rotary damper 32 and the periphery of the spool 30 press against each other in a direction tangential to the respective peripheries, and may press against each other in a radial fashion. The rotary damper 32 and the spool 30 mate so that free rotation of the spool 30 is inhibited by the rotary damper 32. Preferably the periphery of the spool 30 and the periphery of the rotary damper 18 include gear teeth 40 that mate. Although the rotary damper 32 and the spool 30 are shown in contact, it can be appreciated that the rotary damper 32 may alternatively contact the storage drum 34 or the drive gear 36. In an alternate embodiment, the rotary damper 32 is integral with the drive gear 36, or the spool 30.

In this way, the rotary damper 18 limits the maximum angular velocity of the spool 30. Limiting the angular velocity of the spool 30 protects the cartridge 10 from damage. Limiting the angular velocity of the spool 30, in cooperation with the rotary damper 18 pressing against the spool 30 inhibits misalignment of the spool 30 to maximize durability of the cartridge 10. Preferably the rotary damper 18 and the spool 30 include peripheral gear teeth 40 sand 43, respectively, which mate to further improve alignment to optimize movement of the moving components, and improve reliability of the cartridge 10.

When gear teeth are used, the gear teeth yield improved tangential pressure between the spool 30, the rotary damper 18 and the drive gear 16. An additional function of the gear teeth includes maintaining alignment of the spool 30 with respect to the rotary damper 18 and the drive gear 16. Improved alignment of the spool increases the reliability of the cartridge 10.

Furthermore, linkages such as a chain, a belt, or other mechanical transmission mechanism can be used to regulate rotation of the rotary damper or the spool, or both.

The ear bud cable 20 wraps at least partially around the spool 30. The ear bud cable 30 as a first end attached within the spool and a second and attached to ear buds 22. The ear bud cable 30 is flat to optimize alignment of the cable 30 within the spool 30 when the cable 30 is retracted and dispensed. Utilizing a flat cable 24 minimizes the thickness of the cable to maximize the length of the cable that can be wrapped around the spool 30. The flat cable 24 minimizes entanglement of the cable 24, which is optimized, compared with the use of a round cable.

The audio jack 14 includes a circuit board 15 to enable the audio jack 14 to electrically communicate audio signals between the ear bud cable 20 and the audio jack 14 via the spool 30. The circuit board 15 includes a wireless receiver that is Bluetooth enabled for receiving and transmitting audio signals from an audio device attached to the cartridge 10, or remotely positioned with respect to the cartridge 10. The receiver is adapted to transmit audio signals from the microphone 24 via the cartridge 10 to an audio device.

The drive gear and the storage drum each define an outside diameter, the distance between the outside diameter of the drive gear and the outside diameter of the first storage drum is less than two inches.

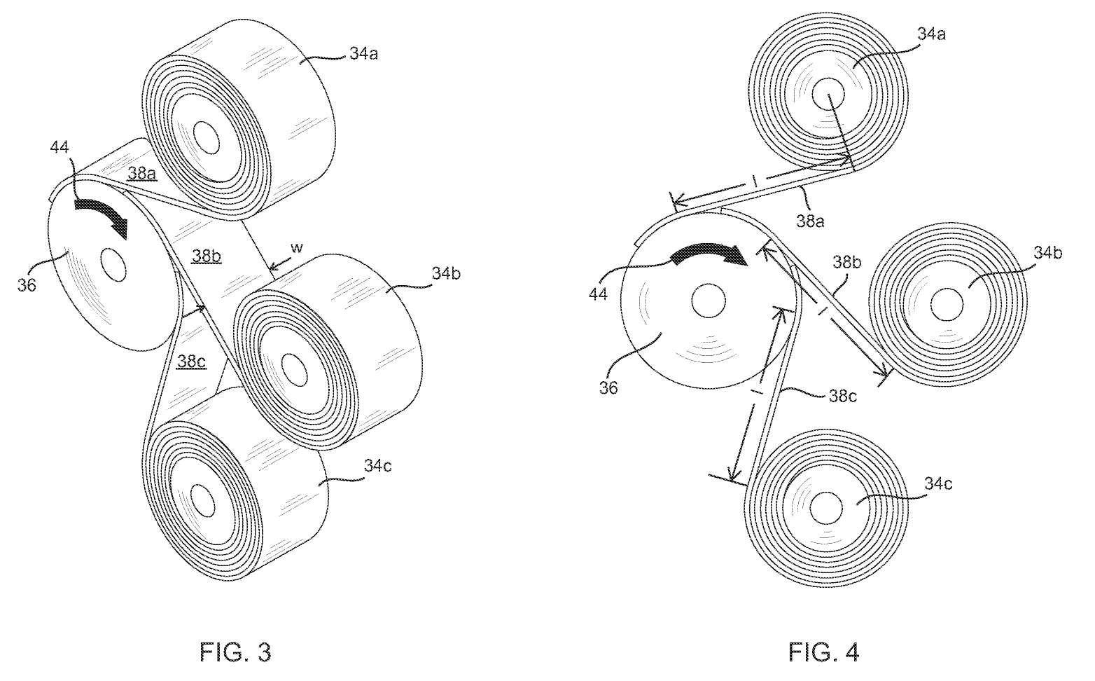

FIG. 3 shows a motor assembly having a drive gear 36 and three storage drums 34a, 34b and 34c. The storage drums 34a, 34b and 34c cooperate to rotate the drive gear 36 in the direction of the arrow 44. A constant torque spring 38a, 38b and 38c extends from the three storage drums 34a, 34b and 34c, respectively. Each constant torque spring 38a, 38b and 38c has a width “w”. The width “w” of the constant torque springs are preferably equal. The width “w” of the constant torque springs is also no greater than the width “w” of the ear bud cable (FIG. 2) to minimize the size of the cartridge 10, and preferably the width “w” of the constant torque spring and the width “w” of the ear bud cable are equal.

FIG. 4 shows a motor assembly including the storage drums 34a, 34b and 34c of FIG. 3 in a side view. Each constant torque spring 38a, 38b and 34c has a length “l” extending from a respective storage drum and the drive gear 36. Preferably the lengths “l” between each storage drum 34a, 34b and 34c and the drive gear 36 are equal, preferably being less than two inches long.

Each length “l” is generally linear to cause the respective torque spring 38a, 38b and 38c to pull on the drive gear 36 with an amount of force dependent on the length “l”. In one embodiment the length “l” is adjustable to optimize the torque applied to the drive gear 36. For example, each storage drum 34a, 34b and 34c adjustably mounts on the housing 12 (FIG. 2).

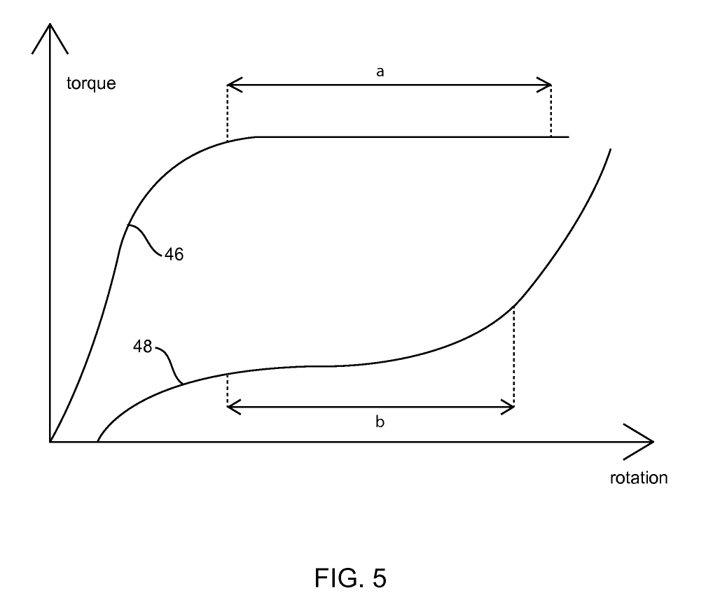

FIG. 5 shows a graph of torque v. storage drum rotation. The line 46 shows an operating range “a” for a constant torque spring. In the range “a” the torque is constant, i.e. varying by no more than +/−10%. Preferably the variability is less than 5%. The line 48 shows variability of the torque using a standard coil spring design, where the torque varies by greater than 10% during the operating range “b”.

While the present invention is disclosed in terms of various embodiments, including preferred embodiments, it can be appreciated that the true scope of the invention is defined only by the appended claims. It should also be appreciated that the present invention can be hard-wired to an audio device, or wirelessly connected to an audio device. Audio devices contemplated for use with the present invention include cellular phones, land-line phones, music players, computers, tablet computing devices, automobile sound systems, home sound systems, and the like.

I claim:

1. A cartridge for managing an ear bud cable, comprising:
a housing having an audio jack;
a spool rotatably mounted in the housing for spooling an ear bud cable;
an ear bud cable wrapped at least partially around the spool, the ear bud cable has a first end and a second end, the first end being in electrical communication with the audio jack and the second end having at least one ear bud,
a motor assembly mounted in the housing, the motor assembly includes a drive gear, a storage drum and a constant torque spring wound at least partially about the storage drum and the drive gear.

2. A cartridge as set forth in claim 1, wherein the drive gear has teeth and the spool has teeth which mate with the teeth of the drive gear to enable the drive gear to rotate the spool.

3. A cartridge as set forth in claim 2 further comprising a damper gear attached within the housing, the damper gear includes teeth that mate with the spool to regulate movement of the spool.

4. A cartridge as set forth in claim 1, wherein the cartridge includes more than one storage drum, one constant torque spring winds about each storage drum and the drive gear.

5. A cartridge as set forth in claim 1, wherein the audio jack includes a circuit board to enable the audio jack to electrically communicate with the ear bud cable.

6. A cartridge as set forth in claim 1, wherein the ear bud cable is flat, having a thickness and a width, wherein the width is more than twice the thickness.

7. A cartridge for managing an ear bud cable, comprising:
a housing having an audio jack including a wireless receiver;
a spool rotatably mounted in the housing for spooling an ear bud cable;
a flat ear bud cable wrapped at least partially around the spool, the ear bud cable has a first end, a width, and a second end, the first end being electrically connected with the audio jack via the spool and the second end having at least one ear bud,
a motor assembly mounted in the housing in operative contact with the spool, the motor assembly includes a drive gear, a storage drum and a constant torque spring wound at least partially about the storage drum and the drive gear;
the storage drum and the drive gear are distanced from each other to enable a length of the spring to extend in a linear manner between the storage drum and the drive gear to apply constant torque to the drive gear.

8. A cartridge as set forth in claim 7, wherein the constant torque spring has a width, and the ear bud cable has a width, the width of the constant torque spring is no greater than the width of the ear bud cable.

9. A cartridge as set forth in claim 7, wherein the constant torque spring has a width, and the ear bud cable has a width, the width of the constant torque spring is approximately the same as the width of the ear bud cable.

10. A cartridge as set forth in claim 7, wherein the constant torque spring applies constant torque to the drive gear, the constant torque varies less than 10% as the drive gear moves.

11. A cartridge as set forth in claim 7, wherein the constant torque spring applies constant torque to the drive gear, the constant torque varies less than 5% as the drive gear moves.

12. A motor assembly for a cartridge for managing an ear bud cable, comprising:
a drive gear and a first storage drum;
a first constant torque spring wound at least partially about the first storage drum and the drive gear for applying torque to the drive gear;
the first storage drum and the drive gear are distanced from each other to enable a length of the spring to extends between the storage drum and the drive gear to apply constant torque to the drive gear.

13. A motor assembly as set forth in claim 12, wherein the constant torque has a variability of no more than +/−10%.

14. A motor assembly as set forth in claim 12, wherein the drive gear and the storage drum each define an outside diameter, the distance between the outside diameter of the drive gear and the outside diameter of the first storage drum is less than two inches.

15. A motor assembly as set forth in claim 14 further comprising a second storage drum with a second constant torque spring wrapped about the second storage drum and the drive gear, the distance between the external diameter of the drive gear and the external diameter of the second storage drum is less than two inches.

16. A device as set forth in claim 16, wherein the drive gear has gear teeth for applying torque to a spool for holding an ear bud cable.

17. A device as set forth in claim 15, wherein the first storage drum and the second storage drum are equidistant from the drive gear.

18. A device as set forth in claim 19, wherein the first constant torque spring and the second constant torque spring have an equal width.
